(19) United States
(12) Patent Application Publication
(10) Pub. No.: US 2026/0109250 A1
(43) Pub. Date: Apr. 23, 2026

(54) BATTERY ELECTRIC VEHICLE

(71) Applicant: Toyota Jidosha Kabushiki Kaisha, Toyota-shi (JP)

(72) Inventor: Kiyoshiro UEOKA, Nagoya-shi (JP)

(73) Assignee: Toyota Jidosha Kabushiki Kaisha, Toyota-shi (JP)

(21) Appl. No.: 19/230,724

(22) Filed: Jun. 6, 2025

(30) Foreign Application Priority Data
Oct. 22, 2024 (JP) 2024-186130

(51) Int. Cl. B60L 53/62; B60L 53/22

(52) U.S. Cl. CPC B60L 53/62; B60L 53/22

(57) ABSTRACT

A battery electric vehicle includes a motor, a drive circuit configured to drive the motor, a power storage device configured to supply electric power to the drive circuit via a power line, a charging connector configured to supply electric power from external charging equipment, and a power line configured to supply electric power from the charging equipment to the power storage device via the charging connector and the power line to execute external charging of the power storage device, the drive circuit including an auxiliary device attached to the charging connector side of the drive circuit, the battery electric vehicle further comprising a current sensor attached between the charging connector and the auxiliary device.

### CROSS-REFERENCE TO RELATED APPLICATION

This application claims priority to Japanese Patent Application No. 2024-186130 filed on Oct. 22, 2024. The disclosure of the above-identified application, including the specification, drawings, and claims, is incorporated by reference herein in its entirety.

### BACKGROUND

### 1. Technical Field

The present disclosure relates to a battery electric vehicle.

### 2. Description of Related Art

As this kind of battery electric vehicle, the following battery electric vehicle has been proposed. The battery electric vehicle includes a motor, a drive circuit (inverter) that drives the motor, a power storage device (battery) that supplies electric power to the drive circuit via a power line, and a charging connector (inlet terminal). The electric power is supplied to the charging connector from external charging equipment (external charger). The battery electric vehicle executes external charging of charging the power storage device by supplying the electric power from the charging equipment to the power storage device via the charging connector and the power line (for example, see Japanese Unexamined Patent Application Publication No. 2024-67878 (JP 2024-67878 A)). In the battery electric vehicle, when an electric power amount actually supplied from the charging equipment to the power storage device deviates from an electric power amount that the power storage device requests from the charging equipment, a determination is made that an abnormality has occurred in the charging equipment.

### SUMMARY

In the above-described battery electric vehicle, in a case where an auxiliary device is provided in the power line, since many of the auxiliary devices do not include a current sensor, it may be impossible to accurately detect the power consumption of the auxiliary device. In this case, an abnormality of the charging equipment or an incompatibility with the charging equipment may not be appropriately determined.

A main object of the battery electric vehicle of the present disclosure is to more appropriately determine the abnormality of the external charging equipment or the incompatibility with the charging equipment in a case where the power consumption of the auxiliary device cannot be accurately detected.

In order to achieve the above-mentioned main object, the battery electric vehicle according to the present disclosure adopts the following means.

A battery electric vehicle of the present disclosure includes
a motor, a drive circuit configured to drive the motor, a power storage device configured to supply electric power to the drive circuit via a power line, and a charging connector supplied with electric power from charging equipment external to the battery electric vehicle, in which the battery electric vehicle executes external charging of supplying electric power from the charging equipment to the power storage device via the charging connector and the power line to charge the power storage device, and the battery electric vehicle includes
an auxiliary device attached to the power line on a charging connector side of the drive circuit, and
a current sensor attached between the charging connector and the auxiliary device.

The battery electric vehicle of the present disclosure includes an auxiliary device attached to the power line on a charging connector side of the drive circuit, and a current sensor attached between the charging connector and the auxiliary device. By using the current detected by the current sensor, an abnormality of the external charging equipment or an incompatibility with the charging equipment can be more appropriately determined in a case where the power consumption of the auxiliary device cannot be accurately detected.

The battery electric vehicle of the present disclosure may further include a determination device configured to transmit a current command to the charging equipment and to determine an abnormality of the charging equipment or an incompatibility with the charging equipment based on a current detected by the current sensor and the current command. In this way, the abnormality of the charging equipment or the incompatibility with the charging equipment can be more appropriately determined.

In addition, the battery electric vehicle of the present disclosure may further include
a booster connected between the charging connector and the power line on the charging connector side of the auxiliary device, the booster being configured to boost electric power supplied to the charging connector to supply the boosted electric power to the power line. In this way, even in a case where the booster is provided, the abnormality of the charging equipment or the incompatibility with the charging equipment can be more appropriately determined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a schematic configuration of a battery electric vehicle according to an embodiment of the present disclosure; and

FIG. 2 is a flowchart showing an example of a determination routine that is executed by the ECU.

### DETAILED DESCRIPTION OF EMBODIMENTS

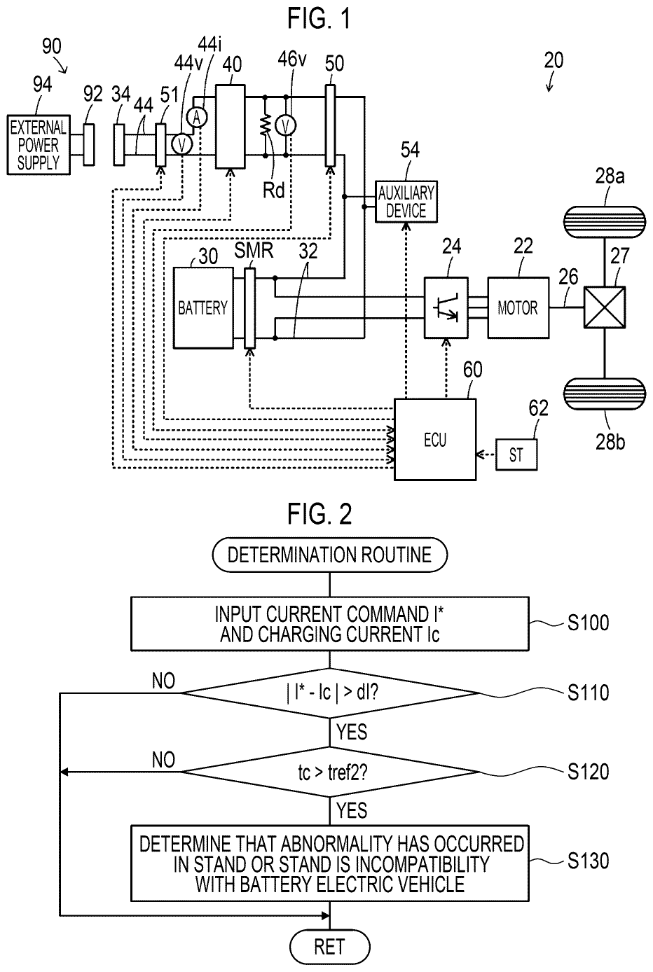

An embodiment of the present disclosure will be described with reference to the drawings. FIG. 1 is a configuration diagram showing a schematic configuration of a battery electric vehicle according to an embodiment of the present disclosure. As illustrated, the battery electric vehicle 20 of the embodiment includes a motor 22 for traveling, an inverter (drive circuit) 24, a battery (power storage device) 30, and a system main relay SMR. The battery electric vehicle 20 includes a charging connector 34, a booster 40, a cutoff relay 50, a charging relay 51, an auxiliary device 54, and an electronic control unit (control device, hereinafter referred to as “ECU”) 60.

The motor 22 is configured as a synchronous motor, and includes a rotor in which a permanent magnet is embedded and a stator in which a three-phase coil is wound. The rotor of the motor 22 is connected to a drive shaft 26 connected to the drive wheels 28a and 28b via a differential gear 27.

The inverter 24 is configured as a well-known inverter circuit having six transistors and six diodes, and is connected to the motor 22 and the power line 32. The inverter 24 is controlled by the ECU 60.

The battery 30 has, for example, a plurality of lithium ion secondary batteries or nickel hydrogen secondary batteries, and is connected to the power line 32.

The system main relay SMR is attached to the power line 32, and connects and disconnects the battery 30, the inverter 24, the auxiliary device 54, and the charging connector 34 side of the cutoff relay 50. The system main relay SMR is controlled by the ECU 60.

The charging connector 34 is configured to be connectable to a stand-side connector 92 of a charging stand (charging equipment) 90. The charging connector 34 is connected to a charging line 44. When the charging connector 34 and the stand-side connector 92 are connected, electric power from the external power supply 94 of the charging stand 90 can be supplied to the charging line 44.

The booster 40 is connected between the charging line 44 from the charging connector 34 and the power line 32 on the charging connector 34 side of the auxiliary device 54, and boosts the electric power supplied to the charging line 44 to supply the boosted electric power to the power line 32. The booster 40 is controlled by the ECU 60.

The cutoff relay 50 is attached to the power line 32 on the booster 40 side of the auxiliary device 54, and connects and disconnects the booster 40, the inverter 24, the battery 30, and the auxiliary device 54. A discharge resistor Rd is attached to the power line 32 on the booster 40 side of the cutoff relay 50. The cutoff relay 50 is controlled by the ECU 60.

The charging relay 51 is attached to the charging line 44 and connects and disconnects the charging connector 34 and the booster 40. The charging relay 51 is controlled by the ECU 60.

The auxiliary device 54 is connected to the power line 32 and is an electric device that operates with the consumption of the electric power of the power line 32, such as an air conditioning system. The auxiliary device 54 is controlled by the ECU 60.

The ECU 60 includes a microcomputer including a CPU or the like. Signals from various sensors are input to the ECU 60 via input ports. Examples of the signal input to the ECU 60 include a voltage V1 from the voltage sensor 44v that detects the voltage of the charging line 44 on the booster 40 side of the charging relay 51. Examples of the signal input to the ECU 60 include a charging current Ic from the current sensor 44i. The current sensor 44i is attached to the charging line 44 on the booster 40 side of the charging relay 51 (attached between the charging connector 34 and the auxiliary device 54) and detects the current supplied to the charging line 44. Examples of the signal input to the ECU 60 include a voltage V2 from the voltage sensor 46v that detects the voltage of the power line 32 on the booster 40 side of the cutoff relay 50. Examples of the signal input to the ECU 60 include a connection signal from a connection detection sensor that detects connection between the charging connector 34 and the stand-side connector 92, and a start signal from the start switch 62. The ECU 60 outputs various control signals, such as a control signal to a plurality of switching elements of the inverter 24 and a drive signal to the system main relay SMR, via the output port. The ECU 60 outputs various control signals, such as a control signal to the booster 40, a drive signal to the cutoff relay 50, a drive signal to the charging relay 51, and a control signal to the auxiliary device 54, via the output port. When the charging connector 34 and the stand-side connector 92 are connected, and the signal line of the stand-side connector 92 of the charging stand 90 and the signal line of the charging connector 34 are connected, then ECU 60 can exchange various signals with the charging stand 90.

In the battery electric vehicle 20 of the embodiment configured as described above, when the start switch 62 is turned on by the user, the ECU 60 turns on the system main relay SMR to be ready on (system on). Thereafter, in a case where the start switch 62 is turned off, the system main relay SMR is turned off to be ready off (system off).

When the connection between the charging connector 34 and the stand-side connector 92 is detected by the connection detection sensor (not shown) attached to the charging connector 34 during a stop of the vehicle in the ready off state, the ECU 60 outputs the current command I* to the charging stand 90. The ECU 60 turns on the system main relay SMR, the cutoff relay 50, and the charging relay 51, and outputs the current command I* to the charging stand 90. The current command I* is a value obtained by dividing a smaller value of a base value Ib determined in advance as the electric power when the battery 30 is charged and an input limit Win of the battery 30 by the inter-terminal voltage of the battery 30. The input limit Win is a maximum value of input electric power allowed for the battery 30, and is determined based on a state of charge SOC of the battery 30 and the temperature of the battery 30. The state of charge SOC is a ratio of a charged capacity to the total capacity of the battery 30. The charging stand 90 that receives the current command I* supplies the direct-current electric power of the current command I* from the external power supply 94 to the charging line 44 via the stand-side connector 92 and the charging connector 34. The ECU 60 controls the booster 40 such that the voltage V2 of the power line 32 is higher than the inter-terminal voltage of the battery 30, and executes the external charging of charging the battery 30 with the direct-current electric power from the external power supply 94 of the charging stand 90.

Next, the operation of the battery electric vehicle 20 of the present embodiment configured as described above will be described. In particular, an operation for determining the abnormality of the charging stand 90 or the incompatibility with the charging stand 90 (the charging stand 90 is out of the specifications of the battery electric vehicle 20) will be described. FIG. 2 is a flowchart showing an example of a determination routine that is executed by the ECU 60. The present routine is repeatedly executed every predetermined time tref1 (for example, every several msec) during the external charging.

When the present routine is executed, the CPU of the ECU 60 inputs the current command I* and the charging current Ic detected by the current sensor 44i (S100). Next, the CPU of the ECU 60 determines whether the absolute value (=|I*−Ic|) of the difference between the current command I* and the charging current Ic is larger than a predetermined difference dI (S110). The predetermined difference dI is a threshold value for determining whether the current command I* and the charging current Ic are the same, and is set to, for example, a value of 0 or a value slightly larger than 0. When the abnormality occurs in the charging stand 90, the charging current Ic is considered to deviate from the current command I*. In addition, when the charging stand 90 is out of the specifications of the battery electric vehicle 20 and is incompatible with the battery electric vehicle 20, the charging current Ic is considered to deviate from the current command I*. Therefore, S110 is a process of determining whether the abnormality has occurred in the charging stand 90. In addition, S110 is a process of determining whether the charging stand 90 is out of the specifications of the battery electric vehicle 20 and is incompatible with the battery electric vehicle 20. Since the charging current Ic includes the current (electric power) consumed by the auxiliary device 54, S110 is a highly accurate determination. The CPU of the ECU 60 determines that the charging stand 90 is normal and the specification of the charging stand 90 matches the specification of the battery electric vehicle 20 when the absolute value of the difference between the current command I* and the charging current Ic is equal to or less than a predetermined difference dI. Then, the CPU of the ECU 60 ends the present routine.

The CPU of the ECU 60 makes the following determination when the absolute value of the difference between the current command I* and the charging current Ic is larger than a predetermined difference dI in S110. That is, the CPU of the ECU 60 determines that there is a possibility that the abnormality has occurred in the charging stand 90 or there is a possibility that the charging stand 90 is out of the specifications of the battery electric vehicle 20 and is incompatible with the battery electric vehicle 20. Next, the CPU of the ECU 60 determines whether the duration tc is longer than a predetermined time tref2 (S120). The duration tc is a time during which the absolute value of the difference between the current command I* and the charging current Ic is continuously larger than a predetermined difference dI. Due to a detection error or the like of the current sensor 44i, the absolute value of the difference between the current command I* and the charging current Ic may be temporarily larger than the predetermined difference dI and then the same. The predetermined time tref2 is a threshold value for determining whether the absolute value of the difference between the current command I* and the charging current Ic is temporarily larger than a predetermined difference dI, and is set as a time longer than the predetermined time tref1, for example. That is, S120 is a process of determining whether the abnormality of the charging stand 90 or the incompatibility between the charging stand 90 and the battery electric vehicle 20 can be confirmed. When the duration tc is equal to or less than the predetermined time tref2, the CPU of the ECU 60 determines that there is a possibility that the abnormality has occurred in the charging stand 90 or there is a possibility that the charging stand 90 is incompatible with the battery electric vehicle 20, but determines that it cannot conclusively confirm either condition. Then, the CPU of the ECU 60 ends the present routine. The CPU of the ECU 60 resets the duration tc to a value of 0 when the absolute value of the difference between the current command I* and the charging current Ic becomes equal to or less than a predetermined difference dI.

When determination is made in S120 that the duration tc is longer than the predetermined time tref2, determination is made that the abnormality has occurred in the charging stand 90 or the charging stand 90 is incompatible with the battery electric vehicle 20 (inconsistent) (S130). Then, the present routine is completed. As described above, the determination is made whether the abnormality has occurred in the charging stand 90 or the charging stand 90 is incompatible with the battery electric vehicle 20 by using the charging current Ic detected by the current sensor 44i. With this, in a case where the power consumption of the auxiliary device 54 cannot be accurately detected, the abnormality of the charging stand 90 or the incompatibility with the battery electric vehicle 20 can be more appropriately determined.

With the battery electric vehicle 20 of the present embodiment described above, the auxiliary device 54 attached to the power line 32 on the charging connector 34 side of the inverter 24 and the current sensor 44i attached between the charging connector 34 and the auxiliary device 54 are provided. As a result, in a case where the power consumption of the auxiliary device 54 cannot be accurately detected, the abnormality of the external charging stand 90 or the incompatibility with the charging stand 90 can be more appropriately determined.

In addition, the abnormality of the charging stand 90 or the incompatibility with the charging stand 90 is determined, based on the charging current Ic detected by the current sensor 44i and the current command I*, together with the transmission of the current command I* to the charging stand 90. As a result, the abnormality of the charging stand 90 or the incompatibility with the charging stand 90 can be more appropriately determined.

Further, a booster 40 that is connected between the charging line 44 from the charging connector 34 and the power line 32 on the charging connector 34 side of the auxiliary device 54, and that boosts the electric power supplied to the charging line 44 to supply the boosted electric power to the power line 32 is provided. As a result, even when the booster 40 is provided, the abnormality of the charging stand 90 or the incompatibility with the charging stand 90 can be more appropriately determined.

In the above-described embodiment, the booster 40 is provided between the charging line 44 from the charging connector 34 and the power line 32 on the charging connector 34 side of the auxiliary device 54, but the booster 40 may not be provided.

In the above-described embodiment, the operation when the present disclosure is applied to the battery electric vehicle 20 that can be externally charged has been described. However, the present disclosure may be applied to a hybrid electric vehicle that can be externally charged and travels by power from an engine and a motor.

The correspondence between the main elements of the embodiment and the main elements of the disclosure described in the column of the means for solving the problems will be described. In the embodiment, the motor 22 is an example of a “motor”, and the inverter 24 is an example of a “drive circuit”. The battery 30 is an example of a “power storage device”, and the charging connector 34 is an example of a “charging connector”. The auxiliary device 54 is an example of the “auxiliary device”, and the current sensor 44i is an example of the “current sensor”.

The correspondence between the main elements of the embodiment and the main elements of the disclosure described in the column of means for solving the problem is an example for specifically describing the embodiment for implementing the disclosure described in the column of means for solving the problem. Therefore, the above-described correspondence does not limit the elements of the disclosure described in the column of the means for solving the problem. That is, the interpretation of the disclosure described in the column of the means for solving the problem should be made based on the description in the column, and the embodiment is merely a specific example of the disclosure described in the column of the means for solving the problem.

Although the embodiment for implementing the above-described disclosure has been described, the above-described disclosure is not limited to the embodiment, and can be implemented in various forms within the scope of the spirit of the above-described disclosure.

The present disclosure can be used in the manufacturing industry of a battery electric vehicle.

What is claimed is:

1. A battery electric vehicle comprising:
a motor;
a drive circuit configured to drive the motor;
a power storage device configured to supply electric power to the drive circuit via a power line; and
a charging connector supplied with electric power from charging equipment external to the battery electric vehicle, wherein:
the battery electric vehicle executes external charging of supplying electric power from the charging equipment to the power storage device via the charging connector and the power line to charge the power storage device; and
the battery electric vehicle includes
an auxiliary device attached to the power line on a charging connector side of the drive circuit, and
a current sensor attached between the charging connector and the auxiliary device.

2. The battery electric vehicle according to claim 1, further comprising a determination device configured to transmit a current command to the charging equipment and to determine an abnormality of the charging equipment or an incompatibility with the charging equipment based on a current detected by the current sensor and the current command.

3. The battery electric vehicle according to claim 1, further comprising a booster connected between the charging connector and the power line on the charging connector side of the auxiliary device, the booster being configured to boost electric power supplied to the charging connector to supply the boosted electric power to the power line.
